(19) United States
(12) Patent Application Publication
(10) Pub. No.: US 2019/0289969 A1
(43) Pub. Date: Sep. 26, 2019

(54) Automatic Swaying Ornament, Carrier and Setting Method Thereof

(71) Applicant: Shenzhen Y&M Jewelry Co., Ltd., Shenzhen (CN)

(72) Inventor: Tianwei Lin, Shenzhen (CN)

(21) Appl. No.: 16/000,886

(22) Filed: Jun. 6, 2018

(30) Foreign Application Priority Data
Mar. 26, 2018 (CN) 201820411478.7
Apr. 27, 2018 (CN) 201810391443.6

(51) Int. Cl. A44C 17/02; B44C 3/12

(52) U.S. Cl. CPC A44C 17/0258; B44C 3/12

(57) ABSTRACT

The present invention discloses an automatic swaying ornament, carrier and setting method thereof, includes a sub-portion inside a base, two connection shafts extended to both sides of the sub-portion; connection slots adapting to the connection shafts arranged in both sides of inner the base, connecting with the sub-portion; a cover plate arranged and welded on the base, covering the connection slots; and hollow structures arranged in walls of the connection slots, adjusting the connection shafts. By arranging a cover plate to cover the connection slots, the connection shafts are enclosed with the sub-portion exposing only. The ornament is easy to be arranged onto a valuable, having an aesthetic appearance. Covering the connection slots prevents any dusts outside from entering and affecting a swaying performance of the sub-portion. Arranging the hollow structures for adjusting the connection shafts ensures the connection shafts keep swaying.

### CROSS-REFERENCES TO RELATED APPLICATIONS

This application claims priority to Chinese Patent Application No. 201810391443.6, filed on Apr. 27, 2018, the content of all of which is incorporated herein by reference.

### FIELD OF THE INVENTION

The present invention relates to the field of jewelry setting technology, and, more particularly, to an automatic swaying ornament, together with a carrier and a setting method thereof.

### BACKGROUND

With an increasing demand of people for jewelry, an ordinary single-piece ornament has been unable to meet people's demands due to a monotony configuration, a constant appearance, and a limited brilliance effect. In prior art, a method of arranging a self-swaying ornament is adopted to improve a self-swaying frequency of a sub-portion, so as to improve a brilliance of a jewelry device.

However, the self-swaying ornament in the prior art still has a plurality of defects. Since a connection shaft contacts to an inner wall of a shaft hole, a long-time swaying may cause a serious wear between the connection shaft and the shaft hole, and after the connection shaft is smoothen, it may affect a swaying effect of the self-swaying ornament, which further affects a brilliance effect of a self-swaying jewelry device; after a long time contact between the connection shaft and the inner wall of the shaft hole, the wear between the connection shaft and the shaft hole becomes serious, and after the connection shaft is smoothen, the swaying effect of the self-swaying ornament will be affected, up to loosing an ability of swaying, which further affects the brilliance effect of the self-swaying ornament, and a service life thereof.

Therefore, the current technology needs to be improved and developed.

### BRIEF SUMMARY OF THE DISCLOSURE

According to the above described defects, the purpose of the present invention is providing an automatic swaying ornament, together with a carrier and a setting method thereof, in order to solve the problems in the prior arts that the connection shaft and the shaft hole are keeping wearing each other, causing the self-swaying ornament a short service life and affecting the swaying effect after a long time usage.

In order to achieve the above mentioned goals, the technical solution of the present invention to solve the technical problems is as follows:

The present invention discloses an automatic swaying ornament, includes a base, inside the base there are a sub-portion and a space applied for the sub-portion to swaying arranged, wherein the automatic swaying ornament further comprises:

a plurality of connection shafts, arranged symmetrically on both sides of the sub-portion, and extending following each side; an end of each of the connection shafts is set as a sharp tip;

a plurality of connection slots, arranged in both sides of an inner side of the base and adapted to the connection shafts, applied to connecting with the sub-portion; an opening of each of the connection slots has a blocking portion arranged, applied to preventing the connection shafts from coming off;

a cover plate, arranged on and welded to the base, applied to covering the connection slots;

a plurality of hollow structures, each is arranged on one side of each of the connection slots, applied to adjusting the connection shafts to ensure that each of the connection shafts is able to keep a continuous sway.

The automatic swaying ornament, wherein each of the connection shafts comprises a blade, the blade is applied to adapting one of the connection slots and making the sub-portion sway.

The automatic swaying ornament, wherein the base further has a plurality of blocking side walls arranged, applied to limiting a range of the sub-portion swaying left and right.

The automatic swaying ornament, wherein the connection shafts are arranged on both sides of a center of gravity of the sub-portion, or are arranged on both sides above the center of gravity of the sub-portion.

The automatic swaying ornament, wherein the connection slots are arranged symmetrically on both sides of the inner side of the base, adapting to the connection shafts, while a number of the connection slots arranged on either side is one or several.

The automatic swaying ornament, wherein when the connection shafts are arranged on both sides of the center of gravity of the sub-portion, a counterweight block is disposed on the sub-portion to adjust a position of the center of gravity of the sub-portion to improve a swaying performance of the sub-portion in a horizontal state.

The present invention further discloses a carrier holding the automatic swaying ornament, wherein the automatic swaying ornament includes a base, inside the base there are a sub-portion and a space applied for the sub-portion to swaying arranged, the automatic swaying ornament further comprises:

a plurality of connection shafts, arranged symmetrically on both sides of the sub-portion, and extending following each side; an end of each of the connection shafts is set as a sharp tip;

a plurality of connection slots, arranged on both sides of an inner side of the base and adapted to the connection shafts, applied to connect with the sub-portion; an opening of each of the connection slots has a blocking portion arranged, applied to preventing the connection shaft from coming off;

a cover plate, arranged and welded on the base, applied to covering the connection slots;

a plurality of hollow structures, each is arranged on one side of each of the connection slots, applied to adjusting the connection shafts to ensure that each of the connection shafts is able to keep a continuous sway;

on a back of the carrier, there is a mounting portion arranged, applied to buckling the automatic swaying ornament to the carrier from the back of the carrier.

The carrier holding the automatic swaying ornament, wherein the carrier includes a dial device, a ring or a bracelet.

The carrier holding the automatic swaying ornament, wherein when the carrier is the dial device, the mounting portion on the back of the dial device is set as a plurality of buckling holes, applied to buckling with the base.

The present invention further discloses a setting method for the carrier holding the automatic swaying ornament, wherein comprising a plurality of following steps:

step A, placing respectively each of the connection shafts of the sub-portion into each of the connection slots in the base accordingly;

step B, by a welding technology, welding the cover plate onto the base, to cover the connection slots before forming the automatic swaying ornament.

step C, buckling the base of the automatic swaying ornament and the mounting portion preset on the back of the carrier, before forming the carrier holding the automatic swaying ornament.

Benefits: the present invention arranges a cover plate on the base, to cover the connection slots, so that the connection shafts are enclosed in the connection slots, having the sub-portion exposing only, which is easy to be arranged onto a valuable, having an aesthetic appearance ensured, while covering the connection slots is able to prevent happening that any dusts outside entering the connection slots, and affecting a swaying performance of the sub-portion. In addition, the present invention arranges the hollow structures, and adjusts the connection shafts through the hollow structures, ensuring the connection shafts being able to keep swaying.

### BRIEF DESCRIPTION OF THE DRAWINGS

FIG. 1 illustrates a perspective view on a first preferred embodiment of an automatic swaying ornament provided in the present invention.

FIG. 2 illustrates a left view on the first preferred embodiment (excluding the cover plate) of an automatic swaying ornament provided in the present invention.

FIG. 3 illustrates an exploded perspective view on the first preferred embodiment of an automatic swaying ornament provided in the present invention.

FIG. 4 illustrates an exploded front view on the first preferred embodiment of an automatic swaying ornament provided in the present invention.

FIG. 5 illustrates a perspective view on a second preferred embodiment (excluding a cover plate) of an automatic swaying ornament provided in the present invention.

FIG. 6 illustrates a left view on the second preferred embodiment (excluding the cover plate) of an automatic swaying ornament provided in the present invention.

FIG. 7 illustrates an exploded perspective view on the second preferred embodiment of an automatic swaying ornament provided in the present invention.

FIG. 8 illustrates an exploded front view on the second preferred embodiment of an automatic swaying ornament provided in the present invention.

FIG. 9 illustrates a perspective view on a third preferred embodiment (excluding a cover plate) of an automatic swaying ornament provided in the present invention.

FIG. 10 illustrates an explored diagram on the third preferred embodiment (excluding a cover plate) of an automatic swaying ornament provided in the present invention.

FIG. 11 illustrates a perspective view on a first preferred embodiment of a carrier holding an automatic swaying ornament provided in the present invention.

FIG. 12 illustrates a left view on the first preferred embodiment of the carrier holding an automatic swaying ornament provided in the present invention.

FIG. 13 illustrates an explored view on a first view angle of the first preferred embodiment of the carrier holding an automatic swaying ornament provided in the present invention.

FIG. 14 illustrates an explored view on a second view angle of the first preferred embodiment of the carrier holding an automatic swaying ornament provided in the present invention.

FIG. 15 illustrates a flow chart on a preferred embodiment of a setting method for the carrier holding the automatic swaying ornament provided in the present invention.

### DETAILED DESCRIPTION OF EMBODIMENTS

The present invention provides an automatic swaying ornament, together with a carrier and a setting method thereof, in order to make the purpose, technical solution and the advantages of the present invention clearer and more explicit, further detailed descriptions of the present invention are stated here, referencing to the attached drawings and some preferred embodiments of the present invention. It should be understood that the detailed embodiments of the invention described here are used to explain the present invention only, instead of limiting the present invention.

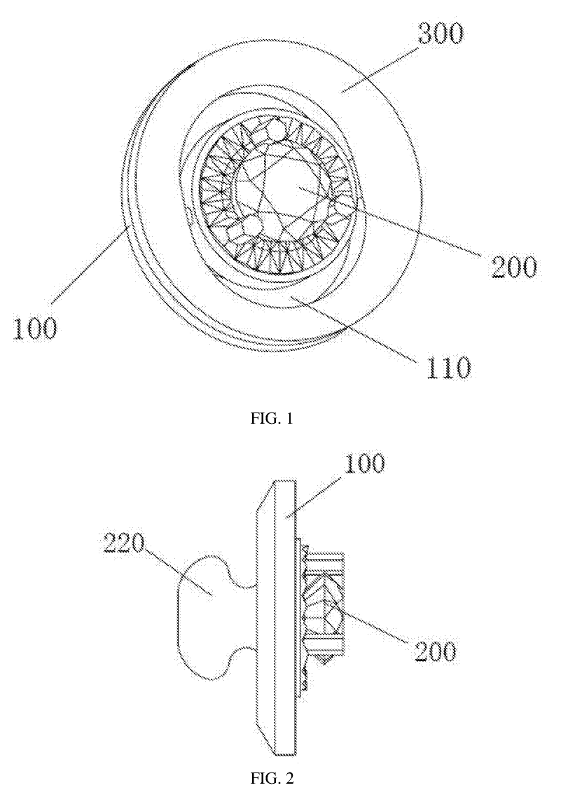

In order to solve a problem of wear between a connection shaft and a connection slot in a self-swaying ornament in prior art, the present invention provides an automatic swaying ornament, as shown in FIG. 1-4, the automatic swaying ornament includes: a base 100, in the base 100, there is a sub-portion 200 arranged (in the present embodiment, the sub-portion 200 is a diamond), and a space 110 applied for the sub-portion 200 to swaying is disposed inside the base 100. The space 110 may be a recess or a through hole disposed in the base 100 (in the present embodiment, it is a through hole), to meet an arrangement and a sway of the sub-portion 200. Specifically, a connection shaft 210 is arranged and extended on each of both sides of the sub-portion 200, and both sides inner the base 100 have a plurality of connection slots 120 arranged, applied to holding the connection shafts 210, to connect with the sub-portion 200; and a cover plate 300 arranged on the base 100, applied to covering the connection slots 120.

The present invention arranges a cover plate 300 on the base 100, to cover the connection slots 120, making the connection shafts 210 be enclosed in the connection slots 120, that makes the connection shafts 210 move within a certain range of the connection slots 120 only, thus avoids the connection shafts 210 coming off from the connection slots 120. In addition, due to the cover plate 300 hiding the connection slots 120, and making the sub portion 200 expose only, it ensures an overall aesthetic appearance of the automatic swaying ornament, and it is able to avoid any debris including dusts outside from entering the connection slots 120, which may affect a swaying performance of the sub-portion 200. Such a hidden arrangement has facilitated an application of the self-swaying ornament in the present invention as a component to a surface of a pretty expensive item, such as a watch dial.

Specifically, in the present embodiment, the cover plate 300 has a shape of a round ring, a position of a middle through hole is a position for the sub-portion to expose, the cover plate 300 may be connected to the base 100 by a welding technology. The cover plate 300 may has a plurality of facets arranged, and each facet may be either a single cut facet or a multi-cut facet. By arranging the facets in the cover plate 300, the facets may reflect glares, and since the sub-portion 200 in the present embodiment is adopting a diamond, which itself has an effect of glaring, thus such a setting makes the cover plate 300 and the sub-portion 200 be visually integrated, making the sub-portion 200 look larger and glarer.

Further, each of the connection shafts 210 comprises a blade 211, the blade 211 is applied to adapting the connection slots 120 and making the sub-portion 200 sway. Each of the connection shafts 210 is configured to have a cross-section in a fan-like shape consisting of two diameters and an arc, and each of the connection slots is configured in a U-shape, the connection shaft 210 of the sub-portion 200 is placed in an dent of U-shaped in each of the connection slots 120. Since the blade 211 has a contact in line with an inner side of the connection slot 120, and the sub-portion 200 itself has a certain weight, thus the sub-portion 200 will be able to sway automatically.

Additionally, the present invention arranges a slightly wider hollow structure 130 on one side of each of the connection slots 120, and the hollow structure 130 is a through hole in one side of the connection slot 120, which makes a user be able to move and adjust each of the connection shafts 210, to ensure that each of the connection shafts 210 is able to keep a continuous sway. For example, when an external foreign matter enters the connection slot 120, and causes the connection shaft 210 unable to sway, now the sub-portion 200 is fixed at a certain position, unable to sway, that affects a lightening effect. The user (normally a professional service provider) may deal with the foreign matter through the hollow structure 130 from the back of the base 100, or move the connection shaft 210, and make the connection shaft 210 return to swaying, that ensures the connection shaft 210 keeps an sway continuously, thus provides a convenience for the user.

Preferably, the connection slots 120 in the present invention are configured in a U shape to facilitate assembling the connection slots 120 and the connection shafts 210. And on an opening of each of the connection slots 120 in the U shape, there is a blocking portion 121 arranged, applied to preventing the connection shafts 210 from coming off. Since the automatic swaying ornament may be set in a plurality of valuables, including a dial device or a ring, which may inevitably move frequently, resulting the connection shafts 210 in a larger movement range, and the present invention arranges the blocking portions 121 in the connection slots 120, ensuring effectively the connection shafts 210 not easy to come off the connection slots 120 when swaying. In order to further reduce a wear between the connection shafts 210 and the connection slots 120, the base 100 has a plurality of blocking side walls 140 arranged, applied to limiting a range of the sub-portion swaying left and right. A distance between two blocking side walls equals to exactly a distance between two tips of the connection shafts 210, or slightly larger than, in order to make sure that a gap between the connection shaft 210 and the blocking side wall 140 on a same side has a smaller gap, as long as not affecting a swaying of the connection shaft 210. In such a way, a reduction of a left and right sway between the connection shafts 210 and the connection slots 120 will reduce a wear between each other, and keep the sub-portion 200 and the connection shaft 210 thereof from moving left and right too much, and causing a stuck before losing a function of the sway, thus it is able to extend a service life of the automatic swaying ornament, as well as ensuring an effect of swaying during working. Preferably, a tip of the connection shaft 210 is set as a sharp tip, with a pretty small gap from a wall of the blocking side walls 140, which not only reduces a contacting area with the wall of the blocking side walls 140, but avoids the connection shafts 210 from moving left and right too much, thus it reduces the wear and increases the sway of the sub-portion 200.

The automatic swaying ornament provided in the present invention is manufactured by a CNC precision machining, having a more exact size of each part, that makes an overall structure of the automatic swaying ornament more stable, while the exact size may effectively avoid the wear caused by the connection shaft 210 swaying left and right.

Preferably, the automatic swaying ornament provided in the present invention has a wide application, which may not only be used as a necklace, a pendant, an earring, but also as an ornament on a surface of a watch. That is, the automatic swaying ornament provided in the present invention may achieve an automatic swaying not only in a vertical direction, but also in a horizontal direction. Of course, there is a difference to achieve the swaying between two states.

Specifically, in the present embodiment, from FIG. 1, it is able to be seen that, the connection shafts 210 are arranged on both sides of the center of gravity of the sub portion 200, and the automatic swaying ornament in the present embodiment is applied in a scene of horizontally placed state, such as a dial device. Therefore, in order to enable the sub portion 200 to keep a continuous swaying, the present embodiment arranges a counterweight 220 on the sub-portion 200, the counterweight 220 locates in the space 110, making a center of gravity of the sub-portion 200 offset to a back of the sub-portion 200. Specifically, as shown in FIG. 2, the counterweight 220 is arranged on the back of the sub-portion 200, in a mushroom shape (a top of the counterweight 220 is a spherical face, and a size is reduced through a circular arc transition before forming a neck part, the neck part further forms a cylinder structure before connecting to the back of the sub-portion 200, and a counterweight 220 is formed similar to the mushroom shape). Arranging the counterweight 220 in the mushroom shape on the back of the sub-portion 200, it is similar to hanging a weight on the back of the sub-portion 200, and through the neck part in a slightly longer length, it makes the center of gravity of the sub-portion 200 as a whole offsets to a direction of the counterweight 220, before forming a stable driving easily. Thus, when one of the connection shafts has a little swaying, it will take the sub-portion 200 keep swaying, that makes the sway more light and more flexible, as long as a frequency of the sway is improved significantly, so as to improve a swaying performance of the sub-portion 200. A plurality of experiments have shown that, adopting the counterweight 220 in the mushroom shape described in the present invention, it is able to move the center of gravity of the sub-portion 200 downwards, and induce a more significant pendulum effect. Comparing to other setting methods that are simply raised from the back of the sub-portion 200, the sub-portion 200 in a whole has a more significant swaying effect, and is easier to chatter.

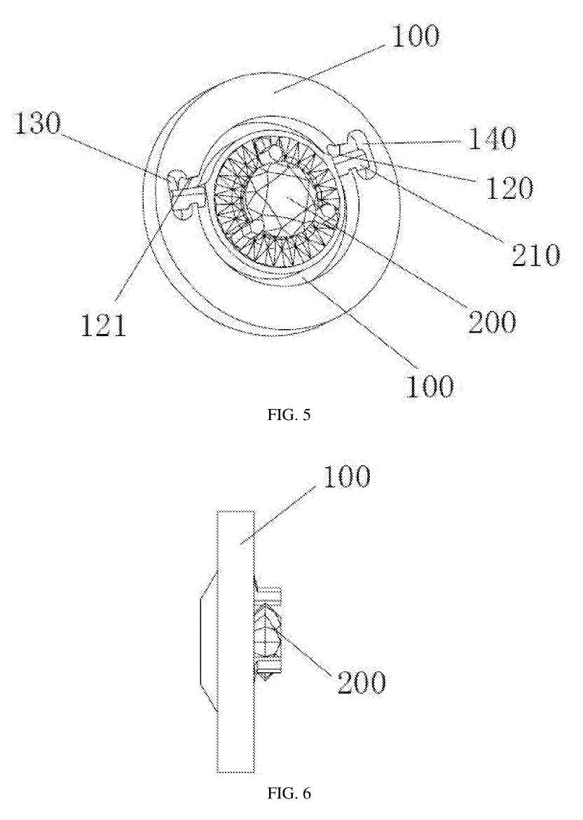

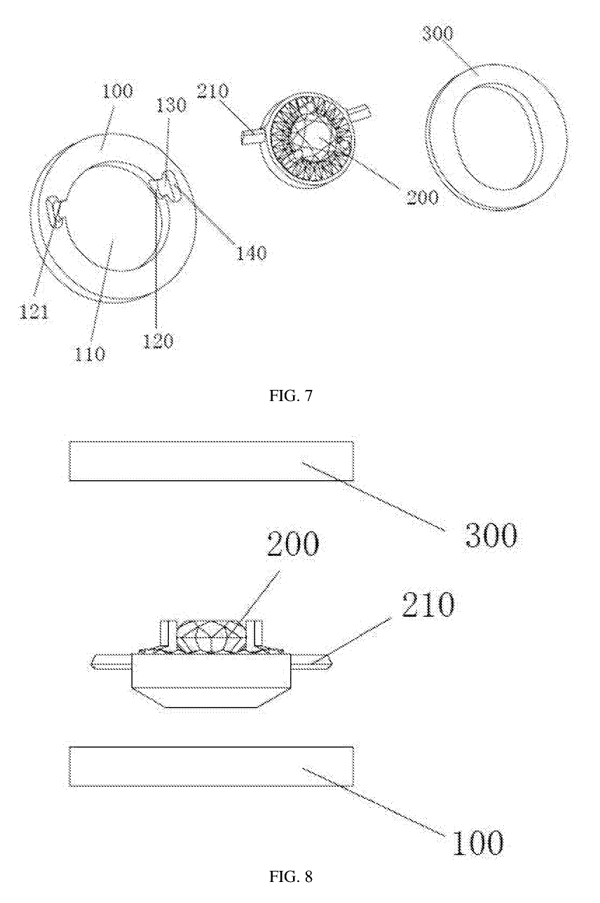

Further, the present invention provides an embodiment on placing the sub-portion 200 in a vertical state, including a plurality of scenes of using an earring, a necklace pendent and more, details are shown in FIG. 5-8. From the FIG. 5, it can be seen that, in the present embodiment, the connection shafts 210 are arranged on both sides above the center of gravity of the sub-portion 200, that is, a position of an arrangement of the connection shafts 210 has a bias to the position of the center of weight of the sub-portion 200 in a vertical direction. So when the sub-portion 200 is set in the necklace pendent or the earring, since the position of the arrangement of the connection shafts 210 has the bias to the position of the center of gravity of the sub-portion 200 in the vertical direction, that means the position of the center of gravity of the sub-portion 200 offsets to a lower end of the sub-portion 200 (and no counterweight is needed). Since the center of gravity moves lower, the sub-portion 200 is easier to sway in the vertical state, thus the swaying performance of the sub-portion 200 is improved.

Of course, in the two embodiments listed above, no matter the connection shafts 210 are arranged on both sides of the center of gravity of the sub-portion 200, or on both sides above the center of gravity of the sub-portion 200, the connection slots 120 are adapting to the connection shafts 210, that is, an arrangement position of the connection slots 120 will be adjusted according to a specific arrangement of the connection shafts 210.

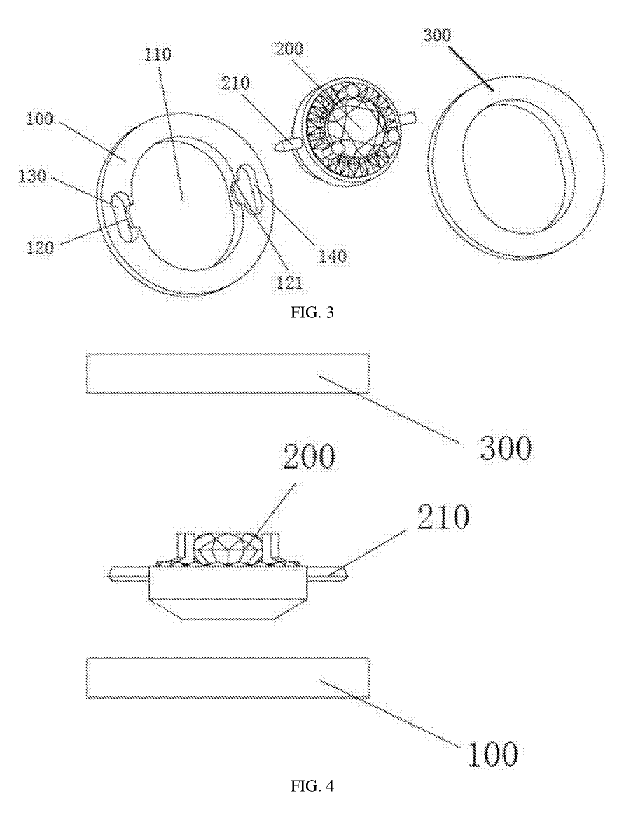

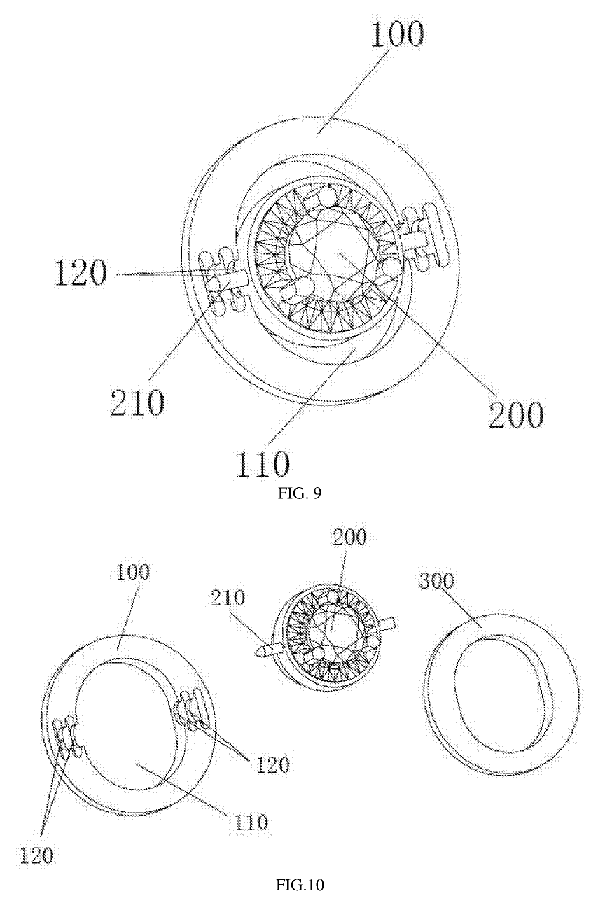

Additionally, the automatic swaying ornament provided by the present invention, wherein the connection slots 120 are arranged symmetrically on both sides inner the base 100, and a number of the connection slots 120 arranged on either side is more than one. From FIG. 3 and FIG. 7, it can be seen that, in the two embodiments listed above, there is one connection slot 120 in each side. However, in order to further avoid that a wear between the connection slots 120 and the connection shafts 210 happens and affects a swaying effect of the sub-portion 200, the present invention further provides another embodiment, as shown in FIGS. 9-10. In the present embodiment, on both sides inner the base 100, there are two connection slots 120 arranged, that makes a contact area between the connection shafts 210 and the connection slots 120 increase, thus avoids any wear pits due to a over small contact area. Besides, since each of both sides inner the base 100 has two connection slots 120 arranged, that makes each side has a backup connection slot 120. Even if one of the connection slots 120 in either side is broken, a swaying effect of the sub-portion 200 will still not be affected. For example, when one of the connection slots in the left side is broken, another connection slot 120 may still connect with the connection shaft 210. That ensures a normal sway of the sub-portion 200.

Of course, a specific arrangement of the connection slot 120 may be decided according to any requirements, it is possible to arrange one connection slot 120 in one side inner the base 100, and arrange two connection slots 120 in another side, it is also possible to arrange two connection slots 120 in either side inner the base 100, similar to the present embodiment.

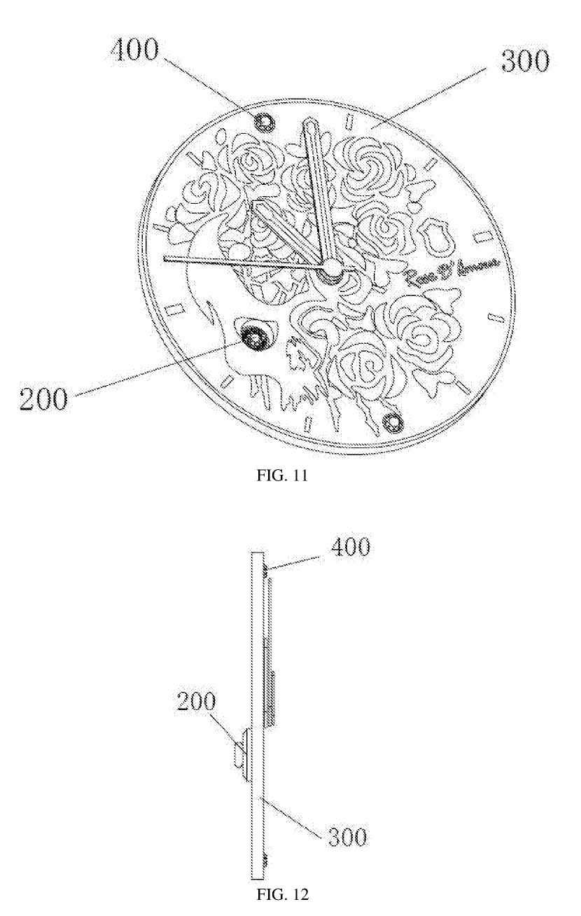

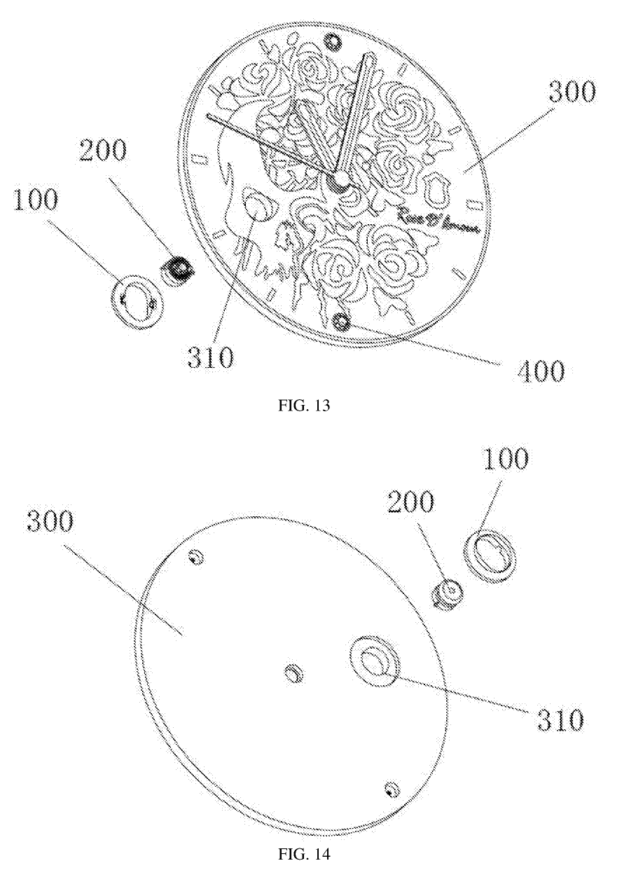

According to the embodiments listed above, the present invention further provides a carrier holding the automatic swaying ornament listed above, the carrier includes any devices being able to load the automatic swaying ornament, to achieve a better lightening effect, including a pendent of a necklace, an earring, or a dial device. The present embodiment takes the dial device as an example, and details are shown in FIGS. 11-14. In the present embodiment, the automatic swaying ornament comprises: a base 100, which has a sub-portion 200 arranged inside. The base 100 further has a space 110 arranged, applied for the sub-portion 200 swaying. Both sides of the sub-portion 200 extend and have a plurality of connection shafts 210 arranged, and both sides inner the base 100 further have a plurality of connection slots 120 arranged, applied to arranging the connection shafts 210, to connect to the sub-portion 200; and a cover plate 300 arranged on the base 100, applied to covering the connection slots 120. The cover plate 300 in the present embodiment may also be achieved by the dial itself. It is possible to achieve a connection between the cover plate 300 and the sub-portion 200 through a plurality of other structures facilitating for fixation, such as a method of buckling for a further firmness increasement.

It may be seen from the figures that, the dial device 400 in the present embodiment has a mounting portion 310 arranged, the mounting portion 310 is applied to buckling the automatic swaying ornament to the dial device 400 from a back of the dial device 400. Comparing to a dial with a fixed jewelry adornment in prior art, the new ornament in the present embodiment is able to sway automatically, that may increase a lightening effect of the ornament effectively, and make the dial look more brilliant.

Specifically, the dial device 400 in the present invention has the mounting portion 310 arranged, applied to installing the automatic swaying ornament, the mounting portion 310 is arranged as a plurality of buckling holes, the buckling holes are step holes with concentric circles inside and outside. Preferably, the step holes are arranged as two holes (a size of the hole close to a back face of the dial device 400 is larger than that close to a front face of the dial device 400), in the present embodiment, a size of a shape of the base 100 is larger (slightly larger) than the size of the step holes, and an outer shape of the base 100 is round, in order to achieve an buckling, a size of the outer shape in round of the base 100 should be larger than the size of the hole close to the back face of the dial device 400. When the base 100 is buckled from the back of the dial device 400, due to the base 100 is oversized, the base 100 can be stably buckled in the step holes, so as to ensure a stability of the base 100 and avoid coming off the dial device 400. Besides, since the base 100 in the present embodiment is buckled from the back face of the dial device 400, thus the sub-portion 200 in the base 100 will locate in an buckling hole in the dial device 400, and a height of the sub-portion 200 will not exceed a front face of the dial device 400, that protects the sub-portion 200 effectively, from rubbing with any external objects and affecting the lightening effect of the sub-portion 200. And from the front face of the dial device 400, it is impossible to see any gaps, ensuring an overall appearance of the dial device 400. Additionally, since the present embodiment has the cover plate 300 arranged and only the sub-portion 200 is exposed, that ensures an overall appearance of the dial device 400.

Of course, in the present embodiment, when applying the automatic swaying ornament onto the dial device or other valuables, the cover plate 300 in the automatic swaying ornament is able to be arranged selectively. For example, when setting the dial device 400 in the present embodiment, the automatic swaying ornament is arranged from the back of the dial device 400, and the buckling holes in the dial device 400 have the sub-portion 200 exposed only, thus the dial device 400 itself acts as the cover plate 300, similarly, the dial device 400 encloses the connection slots 120 and limits a movement range of the connection shaft 210, making the connection shafts 210 not easy to come off the connection slots 120.

Preferably, a setting position and a number of the automatic swaying ornament in the dial device 400 may be set in the dial device 400, according to a requirement of the user. And in order to further increase an brilliant effect of a body of the dial, the present invention further sets a fixed ornament 500 in the dial device 400, for example, sets a plurality of fixed diamonds at a position of 6 o'clock and a position of 12 o'clock, applied to embellishing the dial, and increasing the beauty. Additionally, the present invention may adopt a CNC machining technology to sculpt patterns or words on the front face of the dial device 400, to make the dial device 400 more beautiful.

The carrier holding the automatic swaying ornament provided by the present invention is mainly applied to setting a diamond, and of course, not limited to setting the diamond. It is able to be applied to a plurality of other gemstone jewelry setting devices, such as dials with rubies set or necklace pendants with sapphire.

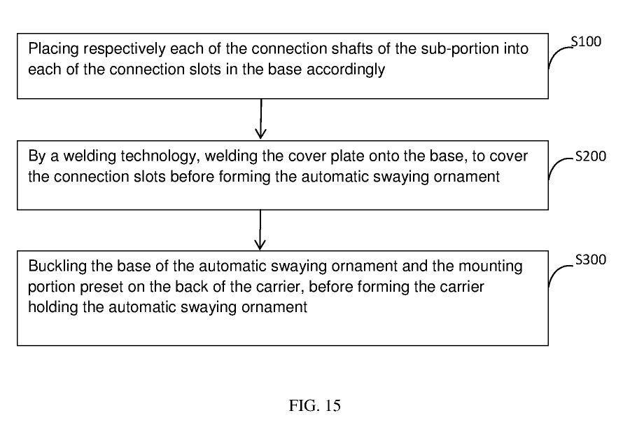

Based on the embodiments listed above, referring to FIG. 15, the present invention further provides a setting method for the carrier holding the automatic swaying ornament, comprising a plurality of following steps:

step S100, placing respectively each of the connection shafts of the sub-portion into each of the connection slots in the base accordingly;

step 5200, by a welding technology, welding the cover plate onto the base, to cover the connection slots before forming the automatic swaying ornament.

step 5300, buckling the base of the automatic swaying ornament and the mounting portion preset on the back of the carrier, before forming the carrier holding the automatic swaying ornament.

The setting method is very convenient and simple to operate, and it is easier to achieve a machining onto the carrier holding the automatic swaying ornament, while the detailed technology solutions and technology benefits have been described in details in the automatic swaying ornament device, and will not be repeated here again.

All above, the present invention discloses an automatic swaying ornament, a carrier and a setting method thereof, includes a base, inside the base there is a sub-portion arranged, two connection shafts are arranged on and extended to both sides of the sub-portion; a plurality of connection slots arranged in both sides of an inner side of the base and adapted to the connection shafts, applied to connecting with the sub-portion; a cover plate arranged on and welded to the base, applied to covering the connection slots; and a plurality of hollow structures, each is arranged on one side of each of the connection slots, applied to adjusting the connection shafts. The present invention arranges a cover plate on the base, to cover the connection slots, making the connection shafts be enclosed in the connection slots, with the sub-portion exposing only, which is easy to be arranged onto a valuable, having an aesthetic appearance ensured, while covering the connection slots is able to prevent happening that any dusts outside entering the connection slots, and affecting a swaying performance of the sub-portion. In addition, the present invention arranges the hollow structures, and adjusts the connection shafts through the hollow structures, ensuring the connection shafts being able to keep swaying.

It should be understood that, the application of the present invention is not limited to the above examples listed. Ordinary technical personnel in this field can improve or change the applications according to the above descriptions, all of these improvements and transforms should belong to the scope of protection in the appended claims of the present invention.

What is claimed is:

1. An automatic swaying ornament, comprising: a base, inside the base there are a sub-portion and a space applied for the sub-portion to swaying arranged, wherein the automatic swaying ornament further comprises:
a plurality of connection shafts, arranged symmetrically on both sides of the sub-portion, and extending following each side; an end of each of the connection shafts is set as a sharp tip;
a plurality of connection slots, arranged in both sides of an inner side of the base and adapted to the connection shafts, applied to connecting with the sub-portion; an opening of each of the connection slots has a blocking portion arranged, applied to preventing the connection shafts from coming off;
a cover plate, arranged on and welded to the base, applied to covering the connection slots;
a plurality of hollow structures, each is arranged on one side of each of the connection slots, applied to adjusting the connection shafts to ensure that each of the connection shafts is able to keep a continuous sway.

2. The automatic swaying ornament according to claim 1, wherein each of the connection shafts comprises a plurality of blades, the blades are applied to adapting the connection slots and making the sub-portion sway.

3. The automatic swaying ornament according to claim 1, wherein the base further has a plurality of blocking side walls arranged, applied to limiting a range of the sub-portion swaying left and right.

4. The automatic swaying ornament according to claim 1, wherein the connection shafts are arranged on both sides of a center of gravity of the sub-portion, or are arranged on both sides above the center of gravity of the sub-portion.

5. The automatic swaying ornament according to claim 4, wherein the connection slots are arranged symmetrically on both sides of the inner side of the base, adapting to the connection shafts, while a number of the connection slots arranged on either side is one or several.

6. The automatic swaying ornament according to claim 5, wherein when the connection shafts are arranged on both sides of the center of gravity of the sub-portion, a counterweight block is disposed on the sub-portion to adjust a position of the center of gravity of the sub-portion to improve a swaying performance of the sub-portion in a horizontal state.

7. A carrier holding the automatic swaying ornament, wherein the automatic swaying ornament includes a base, inside the base there are a sub-portion and a space applied for the sub-portion to swaying arranged, the automatic swaying ornament further comprises:
a plurality of connection shafts, arranged symmetrically on both sides of the sub-portion, and extending following each side; an end of each of the connection shafts is set as a sharp tip;
a plurality of connection slots, arranged on both sides of an inner side of the base and adapted to the connection shafts, applied to connect with the sub-portion; an opening of each of the connection slots has a blocking portion arranged, applied to preventing the connection shafts from coming off;
a cover plate, arranged and welded on the base, applied to covering the connection slots;
a plurality of hollow structures, each is arranged on one side of each of the connection slots, applied to adjusting the connection shafts to ensure that each of the connection shafts is able to keep a continuous sway;
on a back of the carrier, there is a mounting portion arranged, applied to buckling the automatic swaying ornament to the carrier from the back of the carrier.

8. The carrier according to claim 7, wherein the carrier includes a dial device, a ring or a bracelet.

9. The carrier according to claim 8, wherein when the carrier is the dial device, the mounting portion on the back of the dial device is set as a plurality of buckling holes, applied to buckling with the base.

10. A setting method for the carrier holding the automatic swaying ornament according to claim 7, comprising a plurality of following steps:
step A, placing respectively each of the connection shafts of the sub-portion into each of the connection slots in the base accordingly;
step B, by a welding technology, welding the cover plate onto the base, to cover the connection slots before forming the automatic swaying ornament;
step C, buckling the base of the automatic swaying ornament and the mounting portion preset on the back of the carrier, before forming the carrier holding the automatic swaying ornament.

11. A setting method for the carrier holding the automatic swaying ornament according to claim 8, comprising a plurality of following steps:
step A, placing respectively each of the connection shafts of the sub-portion into each of the connection slots in the base accordingly;
step B, by a welding technology, welding the cover plate onto the base, to cover the connection slots before forming the automatic swaying ornament;
step C, buckling the base of the automatic swaying ornament and the mounting portion preset on the back of the carrier, before forming the carrier holding the automatic swaying ornament.

12. A setting method for the carrier holding the automatic swaying ornament according to claim 9, comprising a plurality of following steps:
step A, placing respectively each of the connection shafts of the sub-portion into each of the connection slots in the base accordingly;
step B, by a welding technology, welding the cover plate onto the base, to cover the connection slots before forming the automatic swaying ornament;
step C, buckling the base of the automatic swaying ornament and the mounting portion preset on the back of the carrier, before forming the carrier holding the automatic swaying ornament.
